(19) United States
(12) Patent Application Publication
(10) Pub. No.: US 2007/0122767 A1
(43) Pub. Date: May 31, 2007

(54) Manufacture of dental prostheses

(75) Inventors: Nigel Stephen Workman, Bristol (GB); Brian Timothy Brothers, Bristol (GB)

Correspondence Address: OLIFF & BERRIDGE, PLC, P.O. BOX 19928, ALEXANDRIA, VA, 22320, US

(73) Assignee: Renishaw PLC, Gloucestershire (GB)

(21) Appl. No.: 10/578,255

(22) PCT Filed: Dec. 1, 2004
(86) PCT No.: PCT/GB04/05064

§ 371 Date: May 4, 2006

(30) Foreign Application Priority Data
Dec. 5, 2003 (GB) 0328239.9

(51) Int. Cl. A61C 13/225

(52) U.S. Cl. 433/181

(57) ABSTRACT

A method of determining the shape of a dental prosthesis is disclosed comprising, scanning at least a connecting portion of a preparation, wherein the preparation comprises a first anchor and a connecting portion connected thereto, forming a physical model on the connecting portion to produce a pontic, and scanning at least the pontic whereby the surface of the first anchor is also scanned during a scanning step whereby the scanning steps can be carried out in either order. The preparation may be scanned to provide data concerning relative locations of the first anchor and connecting portion, which may be used to align data obtained during the scanning steps. Also disclosed is a method of producing a model of a dental prosthesis and a method of manufacturing a dental prosthesis.

This invention relates to a method of determining the shape of a dental prosthesis and in particular dental bridges.

Conventionally in the manufacture of bridges a preparation is provided. This preparation is often a positive plaster impression of the section of the mouth which requires the bridge work. It comprises at least two anchors which are located either side of the missing tooth. The preparation is scanned in order to provide the internal dimensions of the bridge. Next, wax is built up in layers over the anchors and at the location of the missing tooth forming a pontic or replacement tooth thus producing a desired external shape for the bridge. The anchors require only a thin layer of wax which represents the thickness of a coping which rests over the anchor surface supporting the bridge. Once the wax-up is complete, it is used as the pattern for a lost wax process and the final bridge is produced from an alloy. The wax-up stage of the procedure is both time consuming and requires skilled labour.

The invention provides a method of determining the shape of a dental prosthesis comprising the steps of:
a) scanning at least a connecting portion of a preparation, wherein the preparation comprises a first anchor and a connecting portion connected thereto;
b) forming a physical model on the connecting portion to produce a pontic; and
c) scanning at least the pontic
   whereby the surface of the first anchor is also scanned during a scanning step and whereby the scanning steps can be carried out in either order.

This scanned data is used to produce a ceramic former which is usually coated with a layer of porcelain to make the final prosthesis.

The physical model is for example, produced out of wax or inlay resin.

In order to produce a coping which fits onto the first anchor and support the bridge, an offset is added to the data produced when the first anchor is scanned. The use of such an offset therefore negates the necessity of physically producing, for example by waxing-up, the first anchor and thus makes the whole process less time consuming.

To ensure that the bridge is comfortable for the wearer, the gum-side surface of the pontic is offset from the gum line by for example 100 microns i.e. the data produced when at least the connecting portion is scanned is offset.

According to a second aspect, the invention provides a method of manufacturing a dental prosthesis comprising:
determining the shape of a dental prosthesis by: scanning at least a connecting portion of a preparation, wherein the preparation comprises a first anchor and a connecting portion connected thereto; forming a physical model on the connecting portion to produce a pontic; and scanning at least the pontic whereby the surface of the first anchor is also scanned during a scanning step and whereby the scanning steps can be carried out in either order;
producing the shape of the dental prosthesis from a ceramic former; and
optionally, coating the produced dental prosthesis with porcelain.

The shape of the dental prosthesis is produced by, for example, machining a ceramic block or pressing ceramic powder into the required shape.

A further aspect of the invention provides a method of producing a model of a dental prosthesis comprising the steps of: scanning a preparation having different features to provide data concerning the relative locations of the different features within the preparation wherein the different features include a first anchor and a connecting portion; dividing a preparation into the different features; individually scanning the different features of the preparation; and producing a model of a dental prosthesis by aligning data from the individual scans using the data concerning relative locations of the different features within the preparation.

The use of a sectioned or divided preparation has the advantage that the margin line (where the prosthesis meets the gum) can be identified for the whole circumference of each feature or tooth of the prosthesis. Additionally, as the or a preparation is used to establish how the features of the prosthesis fit together, no external references or datums need to be used during the scanning procedures.

The invention will now be described by way of example and with reference to the accompanying drawing, of which:

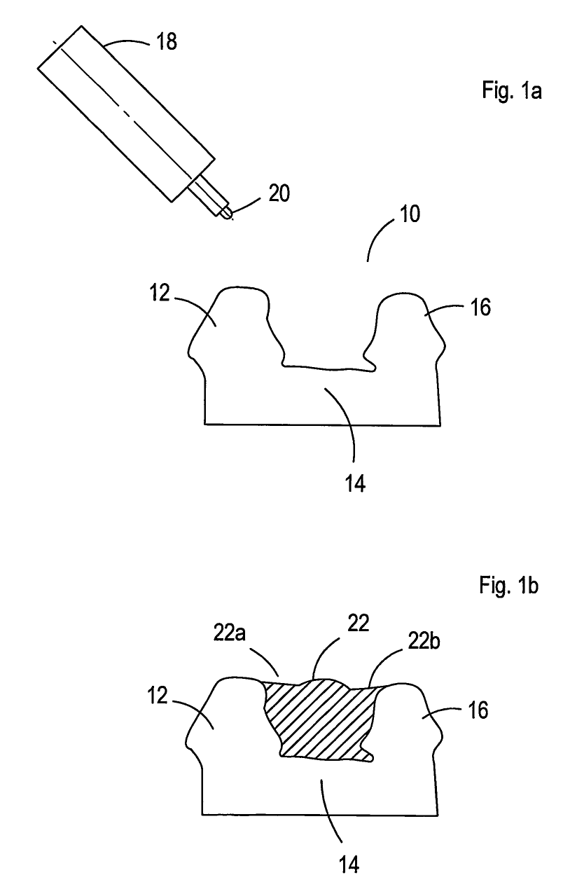

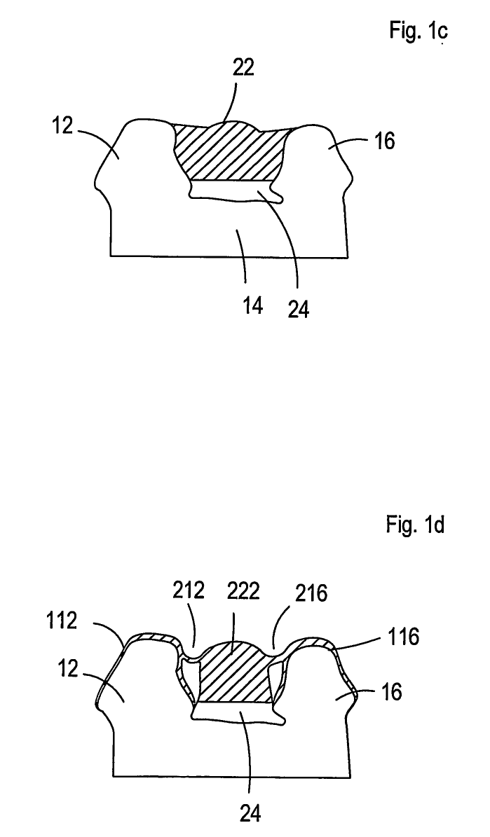

FIGS. 1a-ld show different stages used to determine the shape of a dental prosthesis.

FIG. 1a shows a tooth preparation 10 which in this case comprises a first anchor 12, a connecting portion 14 and a second anchor 16. The first and second anchors are located on opposite sides of the connection portion 14. The connecting portion 14 is the location of a missing tooth which will be replaced with an artificial tooth or pontic by the bridge.

The surface of the first and second anchor 12,16 and the connection portion 14 are scanned using a probe 18 having a scanning tip 20. This may be done as a single block for example by CT or MRI scan or using a non-contact scanning device as described in U.S. Pat. No. 6,217,334. The resultant data from the scan is indicative of the interior surface of the copings which will be produced to cover the first and second anchors.

Alternatively, the different features of the model are separated to allow complete scans of each feature to be made. The complete model is initially scanned to establish the relative locations of the different features of the bridge then, each feature or tooth part is scanned separately. The bridge configuration is determined by combining the data from the individual scans using the data regarding the relative locations of the different features obtained in the initial scan. The data from the individual scans is thus aligned using the data from the complete model scan. The separation of the model into different sections enables data regarding the whole of each tooth part to be obtained.

A number of impressions may be used in this embodiment enabling the models used in each step of the process to be retained in case difficulty arises in, for example, combining the data allowing confirmation of the relative locations of the bridge features. Or, the three portions of the bridge may each be scanned individually as is described in our co-pending UK Patent Application Number GB0327698.7.

Referring now to FIG. 1b a wax model of a replacement tooth or pontic 22 is created on the connecting portion 14. This wax-up model is also scanned.

The wax model of the replacement tooth preferably incorporates connectors 22a,22b which span the gap between the replacement tooth and the first and second anchors (as shown in the diagram). The connectors 22a,22b join the different features of the bridge together. Alternatively, the wax-up of the replacement tooth comprises merely the tooth part and the connectors are added during a different process, such as a data manipulation step by a mathematical technique or visually altering the data, for example.

In order that the bridge is only supported by the two bridge anchors 12, 16 an offset 24 (FIG. 1c) is produced between the connecting portion 14 which represents the gum of the patient and the gum-side surface of the wax-up 22 which represents the replacement tooth. This prevents any damage to the gum from the bridge.

The offset 24 between the connecting portion 14 and the wax-up 22 is produced by manipulation of the data obtained from the two scans that have been conducted, i.e. the data is used to calculate the offset. One way of achieving this is to take the data which represents the surface of the connecting portion 14 and add an offset of for example, 100 microns, to produce a mathematically determined end to the pontic. Alternatively, if the data is represented visually, on a computer monitor for example, then an operator can decide where to locate the end of a pontic by marking a line on the screen.

Instead of choosing a fixed value for an offset which is applied to the whole of the underside of the pontic, the offset can be varied for example to enable easy access to the underside of the pontic for cleaning. Either data manipulation or physical manipulation of the model can achieve this. If data manipulation is selected then a rule relating to the tangency of the manipulated surface may be used for example to prevent an external overhang of the cavity produced between gum and pontic. If physical manipulation is used, wax or another suitable substance is added to the connecting portion prior to it being scanned to collect the data which is indicative of the underside of the pontic.

Referring now to FIG. 1d, in order to support the pontic a shell of material is placed over each anchor 12,16. These shells are known as copings 112 and 116 respectively. The copings 112,116 are not produced by applying a layer of wax to the first and second anchors 12,16. Data from the scan of the first and second bridge anchors is used to calculate an offset, i.e. is manipulated to produce the offset, the amount of the offset indicating the thickness of the coping.

The copings 112,116 are attached to the replacement tooth 222 via connectors 212,216 respectively. The connectors are either made out of wax and scanned or, they can be created mathematically. If the connectors are created mathematically, a set of rules concerning the required strength and aesthetics is used to define their cross section is applied to data collected during the scanning processes. The connectors must be wide and thick enough to impart the required strength, but thin enough that they are not easily seen.

Thus the scanned data of the first and second anchors 12,16 along with the determined end of pontic comprises the inner and under surface of the bridge. The offset data from the scan of the first and second anchors along with the scan of the wax-up 22 produces the exterior surface of the bridge.

In certain circumstances, it may be desirable to apply wax to discrete regions of the anchors. One situation is where the use of a uniform thickness of the ceramic part of a bridge would result in a portion of the prosthesis having a thick layer of porcelain for example, in order to reproduce a realistic shape for the biting surface of an anchor. It is preferred that the layer of porcelain is kept as uniform as possible as it is an aesthetic layer so, in order not to introduce a weakness in the prosthesis, a discrete region of wax is built up on the anchor and scanned. The offset which is used to produce the copings is applied to this scanned data to produce the outer surface of the bridge. The inner surface is produced from the scan of the anchors as previously.

The manipulated data is subsequently used in the manufacture of the custom made prostheses.

In the example described, a standard bridge comprising anchor-pontic-anchor was used. A wide variety of other configurations are possible such as anchor-anchor-pontic; anchor-pontic-anchor-pontic; anchor-pontic-pontic-anchor; and anchor-pontic. The invention is equally applicable to these and other configurations.

1. A method of determining the shape of a dental prosthesis comprising the steps of:
a) scanning at least a connecting portion of a preparation, wherein the preparation comprises a first anchor and a connecting portion connected thereto;
b) forming a physical model on the connecting portion to produce a pontic; and
c) scanning at least the pontic
whereby the surface of the first anchor is also scanned during a scanning step whereby the scanning steps can be carried out in either order.

2. A method according to claim 1 wherein, during a scanning step, the preparation is scanned to provide data concerning relative locations of the first anchor and connecting portion.

3. A method according to claim 2 wherein, data concerning the relative locations is used to align data obtained during the scanning steps.

4. A method according to claim 1 wherein, in addition to producing a physical model of a pontic, connectors which connect the pontic to the first anchor are also produced and wherein said connectors are scanned.

5. A method according to claim 1 wherein, connectors which connect the pontic to the first anchor are created by applying mathematical rules to data collected during the scanning processes.

6. A method according to claim 1 wherein, data produced when the first anchor is scanned is used to calculate an offset.

7. A method according to claim 1 wherein, data produced when at least the connecting portion is scanned is used to calculate an offset.

8. A method of producing a model of a dental prosthesis comprising the steps of:
scanning a preparation having different features to provide data concerning the relative locations of the different features within the preparation wherein the different features include a first anchor and a connecting portion;
dividing a preparation into the different features;
individually scanning the different features of the preparation; and
producing a model of a dental prosthesis by aligning data from the individual scans using the data concerning relative locations of the different features within the preparation.

9. A method of manufacturing a dental prosthesis comprising:
determining the shape of a dental prosthesis according to claim 1; and
producing the shape of the dental prosthesis from a ceramic former.

10. A method according to claim 9 wherein, the dental prosthesis is coated with porcelain.

11. A dental prosthesis produced according to claim 1.
